(19) United States
(12) Patent Application Publication
(10) Pub. No.: US 2005/0263216 A1
(43) Pub. Date: Dec. 1, 2005

(54) Ternary and multi-nary iron-based bulk glassy alloys and nanocrystalline alloys

(75) Inventors: Tsung Shune Chin, Hsinchu (TW); Chih Yuan Lin, Taipei City (TW)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: NATIONAL TSING HUA UNIVERSITY, Hsinchu (TW)

(21) Appl. No.: 11/138,287

(22) Filed: May 27, 2005

(30) Foreign Application Priority Data
May 28, 2004 (TW) 093115253

(51) Int. Cl. H01F 1/153

(52) U.S. Cl. 148/304

(57) ABSTRACT

Disclosed in this invention is a family of ternary and multi-nary iron-based new compositions of bulk metallic glasses which possess promising soft magnetic properties, and the composition selection rules that lead to the design of such new compositions. The embodiment alloys are represented by the formula MₐX_{b}Z_{c}, where M represents at least one of ferromagnetic elements such as iron and may partly be replaced by some other substitute elements; X is an element or combinations of elements selected from those with atomic radius at least 130% that of iron and in the mean time is able to form an M-rich eutectic; and Z is an element or combinations of elements selected from semi-metallic or non-metallic elements with atomic radius smaller than 86% that of iron and in the meantime is able to form an M-Z eutectic; a, b, c are the atomic percentage of M, X, Z, respectively, and a+b+c=100%. When 1%<b<15% and 10%<c<39%, the alloys show a bulk glass forming ability to cast amorphous ribbons/sheets at least 0.1 mm in thickness. When 3%<b<10% and 18%<c<30%, the alloys show a bulk glass forming ability to cast amorphous rods at least 1 mm in diameter. The amorphous phase of these as-cast sheets/rods is at least 95% by volume. This invention also discloses the existence of nano-crystalline phase outside of the outer regime of the bulk glass forming region mentioned above.

This application claims the priority benefit of Taiwan Patent Application Serial Number 093115253, filed May 28, 2004, the full disclosure of which is incorporated herein by reference.

### BACKGROUND OF THE INVENTION

1. Field of the Invention

This invention generally relates to iron-based bulk amorphous alloys and more particularly to the selection rules for compositions of the iron-based soft magnetic bulk amorphous alloys. The ternary and multinary iron-based bulk amorphous alloys and nano-crystalline alloys prepared according to the selection rules exhibit much better properties than traditional amorphous alloys.

2. Description of the Related Art

The amorphous alloys have developed for a long period of time and have wide applications. Among all, the magnetic applications of the amorphous alloys in industrial usage attracted much attention due to their superior magnetic properties. The magnetic amorphous alloys play an important role in amorphous alloys field.

Among all amorphous alloys, iron-based amorphous alloys have been used for many industrial applications. They were melt-spun into amorphous ribbons with a thickness 30˜40 micron and laminated to a core for a distribution transformer. The iron-based amorphous alloys exhibit good soft magnetic properties such as high saturation magnetic flux, low coercive force and high permeability. They have similar magnetic properties with traditional silicon iron but exhibit much lower energy loss about one-third to one-fifth those of traditional silicon irons due to their much higher electrical resistivity. The energy saving is more than two-third which is substantial. Many research laboratories have devoted huge effort on it and also got brilliant economical benefits.

However, the thickness of the traditional iron-based amorphous alloys was limited below 50 micron due to the required high quenching rate about 10⁶K/s so that the processing in winding and heat treatment were complicated and application seriously restricted. Lots of efforts were devoted to improve the glass forming ability to achieve the bulk amorphous alloys with dimension scale up to millimeters to greatly reduce the difficulty and complexity of production process.

The alloys with nano-crystalline phase crystallized within the amorphous matrix were called nano-crystalline alloys. With nano-sized alpha-Fe crystallite dispersed in the amorphous matrix, the saturation magnetization and permeability are greatly enhanced.

With the same composition, the bulk glassy ring is expected to exhibits much better properties than the ring laminated with amorphous ribbons. For soft magnetic properties, the bulk glassy ring exhibits high permeability many times of ribbon ring due to high packing factor with same dimension so that they can be use for high sensitivity instruments. On the other hand, the bulk glassy samples were prepared by a simple casting method which greatly reduces the processes and leads leading to a large energy saving.

However, it is much more difficult to form bulk glassy sample because the size of the bulk glassy ring is much larger and thicker so that their effective cooling rate (10²˜10³ K/s) is much lower comparing to that of ribbon samples (10⁵˜10⁶ K/s). It is desirable to develop the iron-based alloys with large glass forming ability to produce larger bulk glassy sample. Besides the good glass forming ability, the alloys should also exhibits good soft magnetic properties to promote the potential in high frequency applications and energy saving. Thus, the aim of this invention is to develop new materials with such properties to accommodate various processing and applications.

Materials can be divided into two main categories: crystalline or amorphous state according to types of atomic arrangement. The structure with long range order arrangement is called crystalline state and that without amorphous state. Theoretically, with high enough cooling rate, any materials can be frozen from the gaseous or liquid state to amorphous solid state with a random atomic arrangement because the atoms have no enough time to settle into long range order arrangement. The materials in amorphous state possess no grain or grain boundaries. Metals or alloys without long range atomic arrangement are called glassy metals, metallic glasses or non-crystalline alloys.

The first amorphous alloys were prepared using the vapor-deposition method by Kramer et al. in 1930. In 1950, Brener et al. used the electro-deposition method to obtain Ni—P amorphous alloys. However, the amorphous alloys prepared by these two methods are not directly quenched from liquid state to solid state. Until 1960s, Duwez and others used the rapid-solidification method to get Au—Si amorphous alloys. They proved that amorphous alloys can be produced through a high enough cooling rate which suppresses the nucleation and growth processes that lead to crystallization. However, with such a high cooling rate about 10⁶ K/s, the sample size (thickness) was limited below 50 micrometers. They are not useable as structural materials and exhibit low thermal stability. In the 70's, lots of melt-spun amorphous alloys were explored and patented. To name just one, for example, in 1978, a U.S. Pat. No. 4,116,682 disclosed the amorphous alloys MₐT_{b}X_{c} where M is Fe, Co, Ni, Cr and Mn; T is Zr, Ta, Nb, Mo, W, Y, Ti and V; X is the metalloid such as B, Si, P, C, Ge and As. In that patent, low metalloid concentration was claimed, the boron content was only 1-10 at %; and the thickness of amorphous ribbon is below 40 micrometer. During that period of time, people devoted to the exploration of new amorphous systems that were able to become amorphous by the melt-spinning techniques developed at that time. No one ever thought of the nowadays possible ‘bulk metallic glasses’.

In 1980, Chen and others found that the Pd—Ni—P alloys have lower critical cooling rate at only about 10³ K/s to form amorphous state. The first bulk amorphous alloys with size larger than 10 mm diameter were produced by a flux method. The glassy alloys were melted in a quartz crucible with the addition of B₂O₃ to avoid hetero-nucleation.

Since 1988, there has been a breakthrough in the development of bulk amorphous alloys. Prof Inoue and coworkers in Japan developed a lot of alloy systems such as Mg—, Ln- (Ln is lanthanide elements), Zr—, Pd—Cu—, Pd—Fe—, Ti— by water quenching or copper mold casting method. These alloys possess very low critical cooling rate and large super-cooled liquid region. They all possess a better glass forming ability than do Pd—Ni—P alloys. However, the bulk amorphous alloys mentioned above are all non-ferrous alloy systems without ferromagnetic properties. Table 1 lists bulk amorphous alloy systems and the year of invention.

TABLE 1
Bulk metallic glasses and the year of disclosure

| | Year |
|---|---|
| I. Nonferrous | |
| Mg—Ln—M (Ln = Lanthanide metal, M = Ni, Cu or Zn) | 1988 |
| Ln—Al—TM (TM = VL˜VIII group transition metal) | 1989 |
| Ln—Ga—TM | 1989 |
| Zr—Al—TM | 1990 |
| Zr—Ti—Al—TM | 1990 |
| Ti—Zr—TM | 1993 |
| Zr—Ti—TM—Be | 1993 |
| Zr—(Nb, Pd)—Al—TM | 1995 |
| Pd—Cu—Ni—P | 1996 |
| Pd—Ni—Fe—P | 1996 |
| Pd—Cu—B—Si | 1997 |
| Ti—Ni—Cu—Sn | 1998 |
| II. Ferrous and ferromagnetic | |
| Fe—(Al, Ga)—(P, C, B, Si, Ge) | 1995 |
| Fe—(Nb, Mo)—(Al, Ga)—(P, B, Si) | 1995 |
| Co—(Al, Ga)—(P, B, Si) | 1996 |
| Fe—(Zr, Hf, Nb)—B | 1996 |
| Co—Fe—(Zr, Hf, Nb)—B | 1996 |
| Ni—(Zr, Hf, Nb)—(Cr—Mo)—B | 1996 |
| Fe—Co—Ln—B | 1998 |
| Fe—(Nb, Cr, Mo)—(P, C, B) | 1999 |
| Ni—(Nb, Cr, Mo)—(P, B) | 1999 |

These alloys were divided into two categories: ferrous and non-ferrous. We can see that the ferrous alloys have been explored since 1995, while those non-ferrous a few years earlier since 1988. Among all the bulk metallic glasses, Pd—Cu—Ni—P alloys possess the best glass forming ability and the lowest critical cooling rate only about 10⁻¹K/s to form a bulk glassy sample with a diameter up to 100 mm.

For these alloys with large glass forming ability, it is possible to produce bulk amorphous alloys by some traditional solidification processes. This opens up the opportunity to fabricate into various shapes. Their applications are greatly extended.

The amorphous alloys exhibit many unique properties that are much different from those of crystalline alloys due to their disorder structure. They are:

1. Mechanical Properties:

The amorphous alloys have no defect such as dislocation, grain, grain boundary and precipitation due to the amorphous structure. The glassy alloys exhibit much higher strength and hardness because of the lack of the slide planes.

2. Electrochemical Properties:

The amorphous alloys are more homogeneous structure and have much higher corrosion resistivity due to the lack of local high energy regions such as grain boundary, dislocation and precipitation.

3. Electrical Properties:

The random atomic structure results in higher scattering effect to electron movement so that the amorphous alloys have higher electrical resistivity than their crystalline counterpart. Higher electrical resistivity decreases the eddy current under an alternative field leading to a decrement of energy loss.

4. Soft Magnetic Properties:

Ferromagnetic amorphous alloys have no dislocation, grain boundary nor crystal anisotropy hence less pinning effect to magnetic domain so that they exhibits much better soft magnetic properties such as low coercivity and high permeability.

5. Hard Magnetic Properties:

Some hard magnetic amorphous alloys, such as Nd—Fe—Al, possess cluster or phase separation and possess high coercivity (that is to say, hard magnetic properties). Certain of such alloys with suitable thermal treatment may exhibit two orders higher coercivity higher than that of original alloys.

After partial crystallization, amorphous alloys may become nano-crystallized with much improved magnetic properties.

It is the purpose of this invention to explore new compositions of Fe-based amorphous alloys that exhibit feasibility of soft magnetic bulk amorphous alloys that contain only three elements.

Since 1995, Prof. Inoue and others in Japan have discovered two types of ferrous bulk amorphous alloys by copper mold casting method. (1) Soft magnetic bulk amorphous alloys such as Fe—(Al,Ga)-M (M is at least one of the P, C, B, Si, Ge), Fe—Ga—(P,C,B), Fe—(Co,Ni)-TM(Zr,Nb,Ta)—B, Fe—(Zr,Hf,Nb)—B, Fe—(Cr, Mo)—B—C. (2) Hard magnetic bulk amorphous alloy systems such as (Nd, Pr)—Fe—(Al, Si) and Fe—Co—Ln—B.

The properties such as glass transition temperature (Tg), crystallization temperature (Tₓ), saturation magnetization (Iₛ), coercivity force (H_{c}) and effective permeability (μₑ) of some developed bulk amorphous alloys are summarized in Table 2. We can see that they have good thermal stability and large super cooled liquid region (ΔTₓ=Tₓ−T_{g}) up to 85 K. The maximum thickness of the bulk glassy samples reaches 3 to 6 mm stating that they exhibit excellent glass forming ability. On the other hand, their soft magnetic properties are also reasonable. They show high saturation magnetization up to 1.1 T for Fe—(Al,Ga)-M alloy systems and exhibit a effective permeability about 7000˜12000 under an alternative field of 1 kHz. The Fe—(Co,Ni)—(Zr,Nb,Ta)—B alloy systems exhibits the saturation magnetization about 1 T and higher effective permeability about 19000˜25000.

TABLE 2
Thermal and magnetic properties
of some soft magnetic iron-based bulk amorphous alloys

| Alloys | T_{g} (K) | Tₓ (K) | ΔTₓ | Bₛ (T) | H_{c}(A/m) | μₑ (1 kHz) |
|---|---|---|---|---|---|---|
| Fe—Al—Ga—P—C—B | 740 | 795 | 55 | 1.15 | 6.1 | 7000 |
| Fe—Al—Ga—P—C—B—Si | 732 | 792 | 60 | 1.10 | 2.8 | 9000 |
| Fe—Al—Ga—P—B—Si | 737 | 786 | 49 | 1.14 | 6.4 | 12000 |
| Fe—Co—Zr—B | 814 | 887 | 73 | 0.96 | 2.0 | 19100 |
| Fe—Co—Zr—Nb—B | 828 | 913 | 85 | 0.75 | 1.1 | 25000 |

The alloys mentioned above exhibit superior soft magnetic properties. However, these alloys all consist of more than 4 elements, no Fe—B based bulk amorphous alloys (with Fe content higher than 50 at %) consisting of only 3 elements have ever been found. The alloys mentioned above exhibit low saturation magnetization less than 1.5 T due to their complex compositions. And some alloys employ elements that are expensive leading to a high cost.

However, Prof. A. Inoue concluded three empirical rules that have been widely accepted and adopted for achieving high glass forming ability:
1. Multi-component alloys consist of more than 3 elements (conventional ones 5 to 7 elements)
2. Large atomic size ratio among major element more than 12%.
3. Large negative mixing heat

However, the rules mentioned above have been concluded from experimental facts conducted much earlier.

From the discussions above, it is understandable that there would be many common aspects in the existing iron-based bulk amorphous alloys:
(1) They consist of more than 3 elements, conventional ones 5 to 7 elements. There have been not yet iron-based bulk amorphous soft magnetic alloys consist of only 3 elements or less, although bulk amorphous ternary Nd—Fe—Al alloys were disclosed to be with high coercivity (hard magnetic properties).
(2) The alloys consist of a base element of the largest size with smaller metalloid elements as the additive ones. The larger atoms such as Zr or Nb were taken as “additional elements” rather than “main constituent elements”.
(3) The difference in atomic size was expected to be larger, but the extent is limited, as to be moderately larger than 12%.
(4) There should be large negative heats of mixing between the main elements. However, such heats of mixing are not easy to obtain and identify. It is quite inconvenient to design alloys using such data.

Our invention opens up the bottleneck of the existing shortcomings. We jumped away from these old concepts and proposed new selection rules of composition for iron-based bulk amorphous alloys. The iron-based bulk amorphous alloys, represented by MₐX_{b}Z_{c}, are based on two very simple and new selection rules: (1) X is an element with atomic radius at least 130% that of M (Fe), Z is a metalloid or non-metallic element smaller than Fe; (2) there should be eutectic points among M-X, M-Z and X-Z, and the X-M (Fe) eutectic is at the M (Fe)-rich terminal. According to our proposed rules we successfully developed ternary iron-based bulk amorphous alloys that consist of only three elements and exhibit superior soft magnetic properties such as high saturation magnetization up to 1.7 T. On the other hand, this invention also includes the further addition of the fourth elements into the ternary alloys for modification to better properties in order to widen various industrial applications.

Oleg N. Senkov claimed the composition selection rules for bulk amorphous alloys in U.S. Pat. No. 6,623,566. The rules state that the base element (the main element of the alloys) should be the largest and the second abundant element has a size 65-83% that of the base elements. The size of the third abundant element is 70˜90% that of the base element. The fourth element is 80˜92% the size of the based element. However this algorithm based on the biggest base element is completely different from our proposal that the base element is the second largest one. Recently, minor amount of yttrium has been used to improve the glass forming ability of Fe—Zr—Co—Mo—W—B bulk amorphous alloys. However, the amount of the Y addition in this research is less than 2 at. % in the alloy. And the role of the Y is taken as an oxygen scavenger rather than a main composition element.

### SUMMARY OF THE INVENTION

The goal of our invention is to develop new iron-based bulk amorphous alloys in order to competeing the present commercial soft magnetic alloys, Fe—Si—B amorphous ribbons and other soft magnetic materials. To reach this goal, the developed alloys should exhibit high saturation magnetization, low coercive force, high permeability, high electrical resistivity, while low coercivity. The basic alloy design concept of our invention is to take the traditional transition metal-metalloid composition as the base of glass former, hence Fe together with one or more metalloids such as P, Si, B and C were first chosen. These compositions can form amorphous ribbons with a thickness only 30˜40 micrometers by a rapid solidification method which has a quenching rate 10⁵˜10⁸ K/s. These alloys are not able to form thicker or larger amorphous samples not even for a ribbon thicker than 50 micrometer, let alone a “bulk” glassy sample such as a ribbon up to 100˜200 micrometers, or rods with a diameter of 0.5 mm or larger. We jumped away the old concepts mentioned above and proposed new design (composition selection) rules, as delineated below:
(1) For the dual purposes of improving glass forming ability and raising electrical resistivity, we applied the topographical principle as the basics of atomic size selection rules for our alloy design principle. The alloys, represented by the formula MₐX_{b}Z_{c}, where M mainly consists of iron which may partly be replaced by some other elements; X is a metallic element or a combination of metallic elements selected from those with atomic radius at least 130% that of iron and in the mean time is able to form an iron-rich eutectic; and Z is an element or a combination of elements selected from semi-metallic (metalloid) or non-metallic elements with atomic radius at most 86% that of iron, such as phosphorus, silicon, boron and carbon; a, b, c are the atomic percentage of M, X, Z, respectively, and a+b+c=100%. Table 3 lists the atomic size of each element under investigation.

Taking Fe for M and B as Z for an example; firstly, elements with the radius larger 130% than Fe and the larger the better were selected. Thus the elements such as Sr (r_{Sr}=2.15 Å), Y (r_{Y}=1.80 Å), Sn (r_{Sn}=1.62 Å), La (r_{La}=1.88 Å), Ce (r_{Ce}=1.82 Å), Pr (r_{Pr}=1.65 Å), Sc (r_{Sn}=1.64 Å), Nd (r_{Nd}=1.64 Å), Sm (r_{Sm}=1.81 Å), Dy (r_{Dy}=1.77 Å), Er (r_{Er}=1.76 Å), Yb (r_{Yb}=1.70 Å) and etc, were taken into account. Under this principle, the elements with radius smaller than 130% that of Fe such as Nb, Zr, Ta and etc., were ruled out at first. From the viewpoint of hardball model, such a large atomic size difference may bestow difficulty to crystallize during solidification, leading to the ease of formation the amorphous state. On the other hand, the large atomic difference will also increase the local stress at atomic scale resulting in an increased electrical resistivity.

TABLE 3
The atomic radius of some elements and the ratio of radius
between each element and Fe. The Roma letter after element symbol
is the quotations which are listed under the table.

| | Symbol | | | | | |
|---|---|---|---|---|---|---|
| | O (i) | N (i) | C (i) | B (i) | S (i) | P (i) |
| Radius, Å | 0.730 | 0.750 | 0.773 | 0.820 | 1.020 | 1.060 |
| Ratio | 0.588 | 0.604 | 0.623 | 0.661 | 0.822 | 0.854 |
| | Symbol | | | | | |
| | Si (i) | Be (ii) | Ge (i) | Fe (ii) | Ni (ii) | Cr (ii) |
| Radius, Å | 1.110 | 1.128 | 1.220 | 1.241 | 1.246 | 1.249 |
| Ratio | 0.894 | 0.909 | 0.983 | 1 | 1.004 | 1.006 |
| | Symbol | | | | | |
| | Co (ii) | Cu (ii) | V (ii) | Ru (ii) | Rh (ii) | Mn (i) |
| Radius, Å | 1.251 | 1.278 | 1.316 | 1.338 | 1.345 | 1.350 |
| Ratio | 1.008 | 1.03 | 1.060 | 1.078 | 1.084 | 1.088 |

| | Symbol | | | | | |
|---|---|---|---|---|---|---|
| | Pt (i) | Os (ii) | Ir (ii) | Ga (i) | Mo (ii) | W (ii) |
| Radius, Å | 1.350 | 1.352 | 1.357 | 1.360 | 1.363 | 1.367 |
| Ratio | 1.088 | 1.089 | 1.093 | 1.096 | 1.098 | 1.102 |

| | Symbol | | | | | |
|---|---|---|---|---|---|---|
| | Re (ii) | Pd (ii) | Zn (ii) | U (i) | Nb (ii) | Ta (ii) |
| Radius, Å | 1.375 | 1.375 | 1.395 | 1.420 | 1.429 | 1.430 |
| Ratio | 1.108 | 1.108 | 1.124 | 1.144 | 1.151 | 1.152 |
| | Symbol | | | | | |
| | Al (ii) | Au (ii) | Ag (ii) | Ti (ii) | Li (ii) | Tm (i) |
| Radius, Å | 1.432 | 1.442 | 1.445 | 1.462 | 1.519 | 1.560 |
| Ratio | 1.154 | 1.162 | 1.164 | 1.178 | 1.224 | 1.257 |
| | Symbol | | | | | |
| | In (i) | Cd (ii) | Hf (ii) | Mg (ii) | Zr (ii) | Sn (i) |
| Radius, Å | 1.560 | 1.568 | 1.578 | 1.601 | 1.603 | 1.620 |
| Ratio | 1.257 | 1.263 | 1.272 | 1.290 | 1.292 | 1.305 |
| | Symbol | | | | | |
| | Nd (i) | Sc (ii) | Pr (i) | Yb (i) | Lu (ii) | Pb (ii) |
| Radius, Å | 1.640 | 1.641 | 1.650 | 1.700 | 1.735 | 1.750 |
| Ratio | 1.322 | 1.322 | 1.329 | 1.369 | 1.398 | 1.410 |
| | Symbol | | | | | |
| | Er (ii) | Ho (ii) | Dy (ii) | Tb (ii) | Th (ii) | Gd (ii) |
| Radius, Å | 1.756 | 1.766 | 1.774 | 1.781 | 1.800 | 1.801 |
| Ratio | 1.415 | 1.423 | 1.429 | 1.435 | 1.450 | 1.451 |
| | Symbol | | | | | |
| | Y (ii) | Sm (i) | Ce (ii) | Na (ii) | La (ii) | Ca (ii) |
| Radius, Å | 1.802 | 1.810 | 1.825 | 1.857 | 1.879 | 1.976 |
| Ratio | 1.452 | 1.458 | 1.471 | 1.496 | 1.514 | 1.5921 |
| | Symbol | | | | | |
| | Eu (ii) | Sr (ii) | Ba (ii) | K (ii) | Rb (ii) | Cs (ii) |
| Radius, Å | 1.984 | 2.152 | 2.176 | 2.310 | 2.440 | 2.650 |
| Ratio | 1.599 | 1.734 | 1.753 | 1.861 | 1.966 | 2.135 |

Reference:
(i) M. Winter, WebElements. TM. Periodic Table, Professional Edition, http://www.webelements.com, University of Sheffield, UK, 2000.
(ii) International Tables for X-Ray Crystallography, Birmingham, England, 1968.

(2) The metallic element X selected by the selection rules of the present invention should also be able to form eutectic with both M (Fe) and Z. The X—Fe eutectic should be at the iron-rich terminal. This is to reach a negative heat of mixing on one aspect, and to minimize the amount of X element needed (such that a high Fe content can be maintained). Since phase diagrams of binary alloys are readily available, it is easy to search and select qualified elements. This principle of eutectics is much more convenient to apply than does the search of ‘large negative mixing heat’ from literature. The aforementioned big elements which will not form eutectic point at the iron-rich end are Sn, La, Ce, Pr, Nd, Sm, Eu, Gd and Th were not likely useful.
(3) Considering chemical, physical and other relevant properties, we omitted some selected elements that will lead to unsuitable properties. In view of chemical properties, the alkaline-earth metals such as Li, Na, K; and light-rare-earth metals such as La, Ce, Pr, Nd and Sm are too unstable and easy to be oxidized in air. These elements were not taken into consideration as the main constituent although they may be used as additives to modify properties. In view of physical properties, the elements such as Pr and Nd being easy to form hard magnetic phase with Fe and B (e.g. Pr₂Fe₁₄B and Nd₂Fe₁₄B phases) so that they were skipped due to the unsuitable magnetic properties violating the goal of our invention. Some elements such as Tm and Lu were also skipped because they are too rare and too expensive for industrial production.

After choosing the elements, X and Z, according the selection rules stated above, we started the experiments at the eutectic compositions, and then we gradually extended to hypo- and hyper-eutectic compositions to look for suitable composition ranges; similarly, we continued to work out suitable compositions around the Fe-Z eutectic composition.

Finally, according to the requirements of the structure, magnetic, mechanical and surface properties, suitable additive elements were chosen to replace a portion of the X and Z elements. The selection of these additive elements is not restricted by the previous design (selection) rules. For example, without decreasing the glass forming ability, M (Fe) can be partially replaced by Co, Ni, A1, Sc, Ti, V, Cr, Mn, Zr Ga, Sn and etc; X can be partially replaced by La, Ce, Zr, Nb, Mo, Hf and etc., while the element Z (B) can also be partially replaced by N, Si, P, C, Ge and S.

According to the rules stated above, suitable X elements are not many. Only the transition metals Scandium (Sc) and Yttrium (Y), and some rare earth elements Dysprosium (Dy), Holmium (Ho), Erbium (Er) and etc., obey our selection rules. We designed in the present invention the alloy systems shown below, and then subsequently improved them.
A. Since Yttrium being the most abundant and cheapest elements among Sc, Y, Dy, Ho, Er, we first examined the glass forming ability of Fe—Y—B ternary alloys.
B. Then Fe—R—B ternary alloys were studied in which R being one of Sc, Dy, Ho, Er.
C. Based on the amorphous alloys obtained above, Fe was replaced in part by a small amount of Co, Ni, Al, Ga, Sn or other transition metals; Y or R was partially replaced by a small amount of transition metals or rare earth elements, such as Nb, Ta, Mo, Ti, Cu, Sc, Sn, La, Ce, Pr, Nd, Sm, Eu, Gd and Tb; B was partially replaced by one or a combination of C, N, Si, Fe, P and S.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is the experimental flow chart of this invention.

FIGS. 2A and 2B show the typical X-ray diffraction (XRD) patterns of cast rods prepared by the copper mold casting method, wherein FIG. 2A shows an XRD pattern of a cast Fe₈₀Y₄B₁₆ rod with 0.5 mm in diameter; and FIG. 2B shows the XRD patterns of cast Fe₍₆₆₋₇₄₎Y₍₄₋₆₎B₍₂₂₋₂₆₎ rods with 1-2 mm in diameter.

FIG. 3 shows composition range to cast glassy rods with a diameter at least 0.5 mm.

FIG. 4 shows composition range to cast glassy rods with a diameter at least 1.0 mm.

FIG. 5 shows the DSC curves of the glassy Fe_{(96-c)}Y₄B_{c} (c=22, 24, 26) rods 1 mm in diameter.

FIG. 6 shows the DSC curves of the glassy Fe_{(94-c)}Y₆B_{c} (c=20, 22, 24, 26) rods 1 mm in diameter.

FIG. 7 shows the DSC curves of the glassy Fe_{(92-c)}Y₈B_{c} (c=20, 22, 24, 26) rods 1 mm in diameter.

FIG. 8 shows curie temperature of the bulk amorphous alloys.

FIG. 9 shows electrical resistiviy measurement results of Fe—Y—B amorphous ribbons with a thickness 0.150 mm.

FIG. 10 shows an XRD pattern of a Fe₇₇Y₅B₁₈ cast rod 1 mm in diameter.

FIG. 11 shows composition range of amorphous melt-spun ribbons with the thickness of at least 0.1 mm.

### DETAILED DESCRIPTION OF THE PREFERRED EMBODIMENT

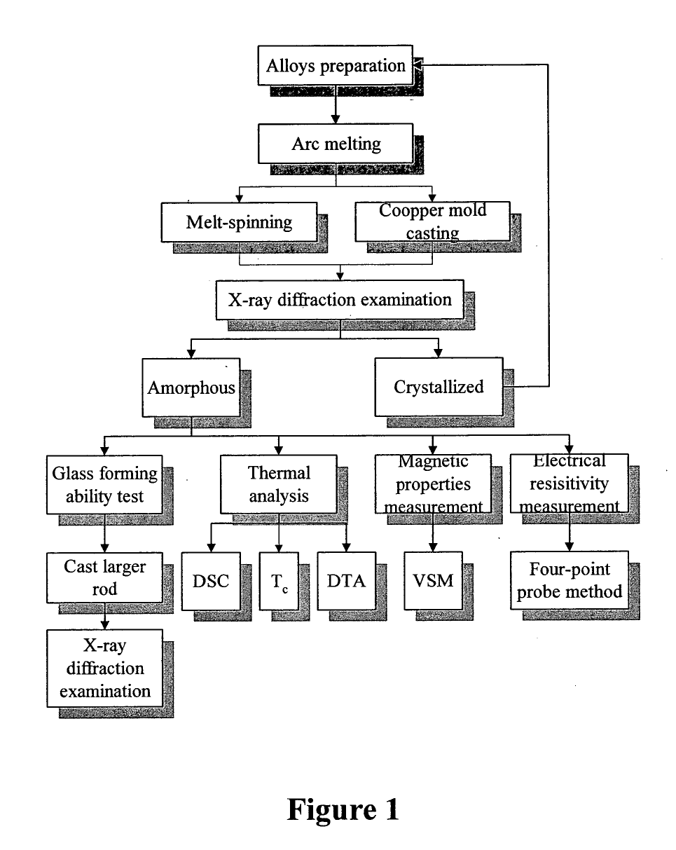

The experimental procedures of this invention are shown in FIG. 1.

1. Preparation of Bulk Amorphous Samples

1) Preparation of Alloys
i) The constituent elements are pure elements (at least 99.8% purity). Some elements were from master alloys such as Fe—P and Fe—C alloys. Boron was either pure boron chip (>99.8% purity) or from Fe—B master alloys.
ii) The alloys were prepared at least 30 gram per batch according to their weight percentage.
iii) The weighted raw materials were put into a water-cooled copper crucible and put into an arc furnace chamber.
iv) The chamber was pumped down to a vacuum of 10⁻² Pa and then back-fill with pure argon to 1 atm, and then pumped to a vacuum of 10⁻² Pa again. This purge processes were repeated at least 5 times.v) The raw materials were then melted and mixed by arc melting, at least for five times to well mix the alloys.
   2) Preparation of Amorphous Rod Samples

Approximately 2 gram of the pre-melt alloy was put into a quartz tube and then put into the induction melting furnace. The chamber was pumped down to 10⁻² Pa and then back-filled with pure argon to 1 atm and then pump to 10⁻² Pa. This process was repeated at least five times to minimize residual oxygen in the chamber. The alloy was melted in the quartz tube by induction melting then inject-casting into an underneath copper mold using argon of 25 kPa. The copper mold has different sections of rod cavities that have diameters of 0.5 mm, 1.0 mm, 2.0 mm, 3.0 mm and 4.0 mm, respectively. After injecting casting, the samples were taken out from the mold for further treatments and characterization.

3) Preparation of Thick Ribbons

Approximately 1 gram of the pre-melted alloy was put into a quartz tube that has a small underneath opening. The chamber was pumped down to 10⁻² Pa and then back-filled with pure argon to 1 atm and then pump to 10⁻² Pa. This process was repeated at least five times to minimize residual oxygen in the chamber. The alloy was melted in the quartz tube by induction melting then inject-casting onto a rotating copper wheel with various speeds to obtain ribbons with thickness of 0.1 mm and above.

2. Analyses and Measurements

1) The Structure Analysis

The samples made by copper mold casting were polished at the longitudinal cross section and then examined using X-ray diffractometry (XRD), Rigaku RU-H3R (Cu K_{α1} 1.5415 Å), by the traditional Bragg diffraction method, θ/2θ, to identify the structure. The scan was from 20 to 80 degree at a scanning speed of 4 degree/min. For the ribbons, the free surface (air surface) was examined likewise. Polished and etched surface of cast rods was examined by a metallography microscope or a scanning electron microscope to identify the area fraction of crystalline phase that tends to be easier etched by acids than amorphous phase.

2) Thermal Analyses

A differential scanning calorimeter, DSC (Setaram, DSC 131), was used to measure the glass transition temperature and crystallization temperature, and a differential thermal analysis, DTA (Seiko DTA 5500), to measure the melting temperatures at a heating rate of 0.33 K/s.

3) Magnetic-Thermal Gravimetric Analyses

Curie temperature (T_{c}) was measured by a magnetic-thermal gravimetric analyzer (M-TGA).

4) Measurements of Hysteresis Loops

The hysteresis loop of the samples was measured by a vibrating sample magnetometer (VSM) to get their saturation magnetization, coercivity force and other relaxant magnetic properties.

5) Measurements of Electrical Resistivity

The electrical resistivity was measured on melt-spun ribbons by a typical four-point probe method.

6) AC Field Magnetic Properties Measurements

The permeability of the cast glassy rings was measured with an impedance meter under 50 Hz, 60 Hz, 1 kHz, respectively.

3. The Resultant Ternary and Multinary Iron-Based Bulk Amorphous Alloys

This invention brings new compositions of ternary and multinary iron-based bulk amorphous alloys represented by the formula MₐX_{b}Z_{c} where M mainly consists of iron and may be partly replaced by some other substitution elements; M is an element or a combination of elements selected from those with atomic radius more than 130% that of iron and in the mean time is able to form an iron-rich eutectic (such as Sc, Y, Dy, Ho, Er); and Z is an element or a combination of elements selected from semi-metallic or non-metallic elements with atomic radius smaller than 86% that of iron such as P, Si, B, C; a, b, c are the atomic percentage of M, X, Z, respectively, and a+b+c=100%. When 1%<b<15% and 10%<c<39%, the alloys show a bulk glass forming ability to cast amorphous sheets at least 0.1 mm in thickness. When 2%<b<15% and 12%<c<39%, the alloys show a bulk glass forming ability to cast amorphous rods at least 0.5 mm in diameter. When 3%<b<10% and 18%<c<30%, the alloys show a bulk glass forming ability to cast amorphous rods at least 1 mm in diameter. The volume percentage of amorphous phase in the as-cast sheets/rods is larger than 95% as examined by metallography. The resultant properties of the bulk amorphous alloys with suitable compositions are characteristic of much higher electrical resistivity (larger than 200 μΩ-cm), saturation magnetization 1.3 T˜1.8 T, permeability larger than 2000 under 1 kHz, coercivity lower than 80 A/m and core loss less than 0.2 W/kg under 60 Hz, 1.2 T.

### EXAMPLE 1

Rods of Fe_{100-b-c}Y_{b}B_{c} Alloys 0.5 mm in Diameter by a Copper Mold Casting Method

1) Structure Analysis

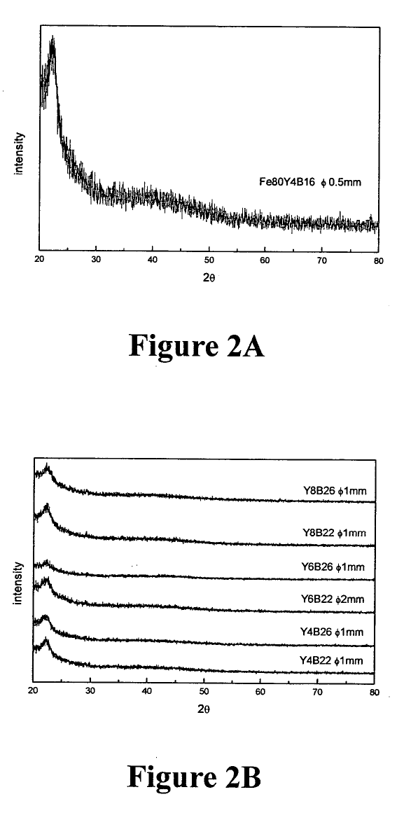

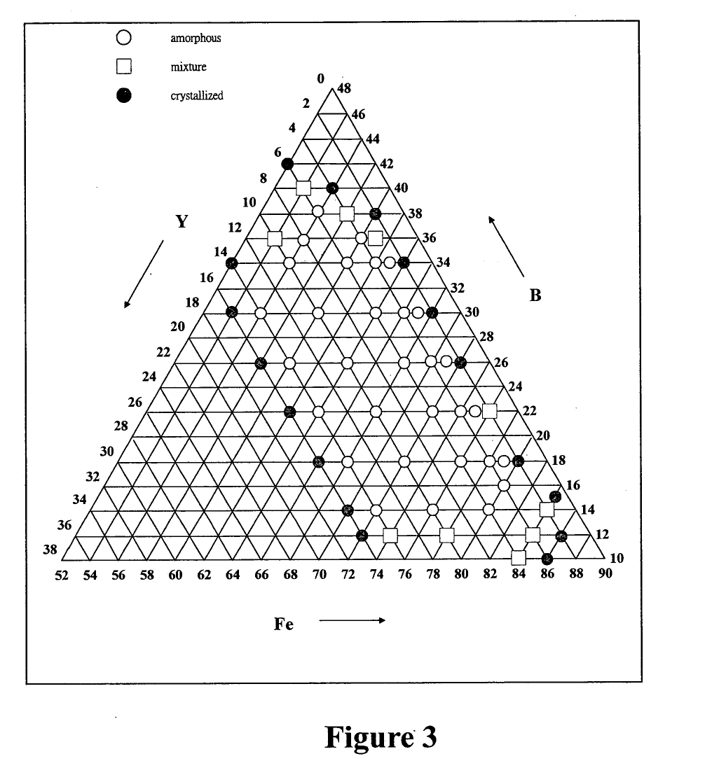

Fe_{100-b-c}Y_{b}B_{c} alloys were prepared, where b=1-16 at. %, c=10-42 at. % and melted then injection-cast into rods of 0.5 mm in diameter. They were examined by XRD to identify the structure. FIG. 2A shows a typical XRD pattern of the cast rods of 0.5 mm diameter. It shows that the examined rods consist of amorphous phase without detectable crystalline phases. FIG. 3 shows the composition ranges of amorphous, mixture phases and crystalline structure as examined by XRD. FIG. 3 shows that glassy rods with a diameter of at least 0.5 mm can be formed as the composition lies in the region of 54 at. %<a<84 at. %, 2 at. %<b<15 at. %, 12 at. %<c<39 at. %. This result shows that the Fe—Y—B alloys exhibits very good glass forming ability and a wide composition range of glass formation.

### EXAMPLE 2

Rods of Fe_{100-b-c}Y_{b}B_{c} Alloys 1 mm in Diameter by a Copper Mold Casting Method

1) Structure Analysis

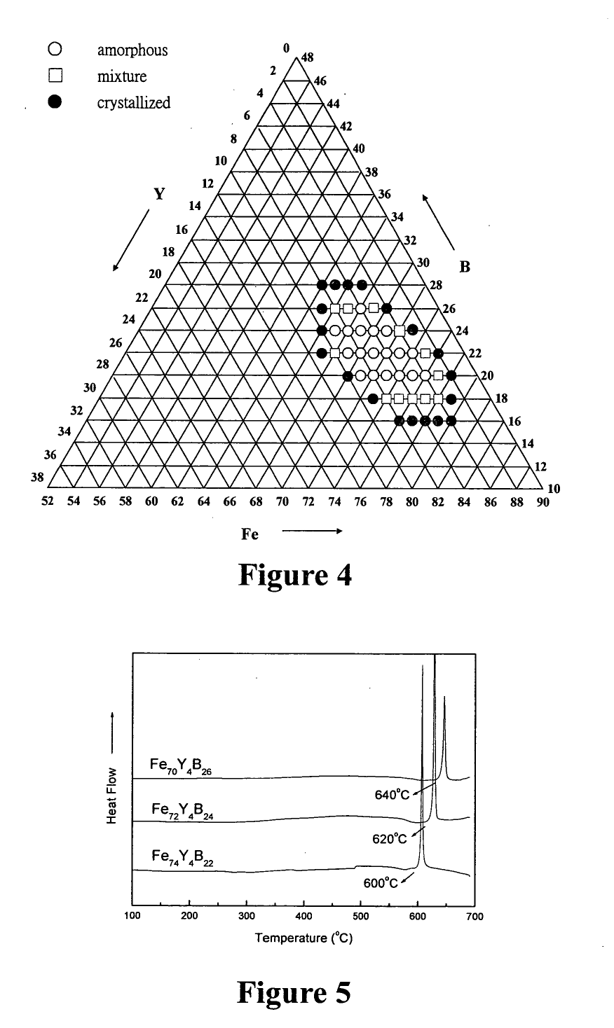

Fe_{100-b-c}Y_{b}B_{c} alloys were prepared where b=1-16 at. %, c=10-42 at. % and melted, injection-cast into 1 mm rods and then examined by XRD. FIG. 2B shows the typical XRD pattern of cast rods 1 mm in diameter. It shows that the examined rod consists of mainly amorphous phase without detectable crystalline phases. FIG. 4 depicts the composition ranges of amorphous, mixture phases and crystalline structure examined by XRD.

Glassy rods with a diameter of at least 1 mm is possible within the composition region 66 at. %<a<78 at. %, 3 at. %<b<10 at. %, 18 at. %<c<27 at. %. This result shows that the Fe—Y—B alloys exhibits a very good glass forming ability and a wide bulk glass forming composition range specifically for the composition Fe₇₂Y₆B₂₂, which is able to form bulk glassy rods with a diameter of at least 2 mm. We can see that the composition range for forming 1 mm bulk glassy rod is much smaller than that of 0.5 mm bulk glassy rods.

2) Thermal Analyses

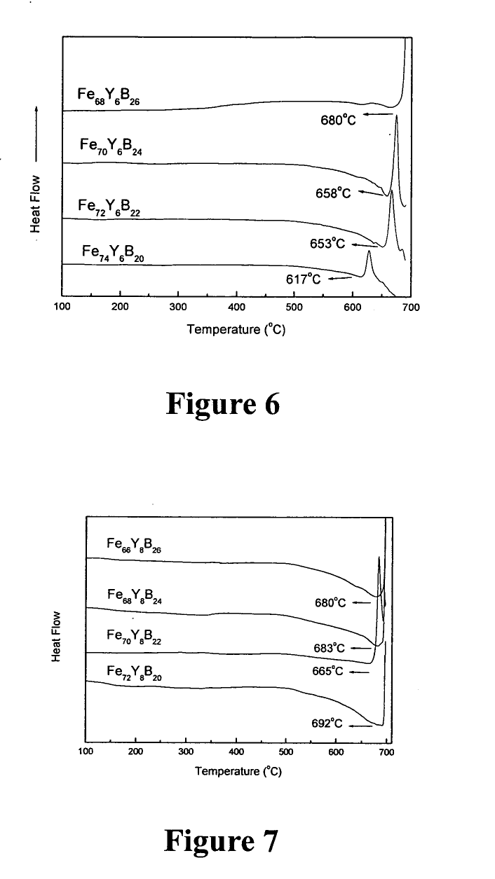

The glassy samples were examined by differential scanning calorimetry to explore the thermal properties as depicted in FIGS. 5 to 7. The results show that the higher Y and B contents lead to a higher glass transition temperature and crystallization temperature. The crystallization temperature is around 650° C. which is much higher than normal service temperature revealing their good thermal stability. The results show that they exhibit wide supercooled liquid region at least 40 K and the maximum up to 60 K.

3) Curie Temperature

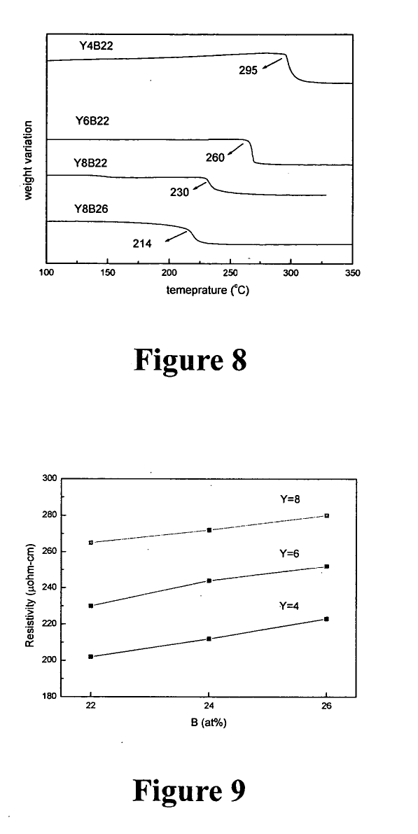

The Curie temperatures measured by M-TGA were depicted in FIG. 8. The results show that the Curie temperature decreases with increasing Y and B contents. The Curie temperature lies approximately within 200 to 250° C. which is high enough for service.

4) Magnetic Properties

Hysteresis loops were measure by a VSM. The results show that the alloys exhibits high saturation magnetization and low coercive force. The highest saturation magnetization reaches 1.7 T as shown in table 4. The results also show that the core loss of these alloys is less than 0.2 W/kg (60 Hz, 1.2 T).

TABLE 4
Magnetic properties of some iron-based ternary bulk amorphous alloys.

| Amorphous alloy | Bs (T) | Hc (A/m) |
|---|---|---|
| Fe₆₈Y₆B₂₆ | 1.2 | <40 |
| Fe₇₂Y₆B₂₂ | 1.4 | <20 |
| Fe₇₀Y₄B₂₆ | 1.3 | <40 |
| Fe₇₄Y₄B₂₂ | 1.5 | <40 |
| Fe₇₈Y₄B₁₈ | 1.6 | <40 |
| Fe₈₀Y₄B₁₆ | 1.7 | <40 |

5) The Electrical Resistivity

Typical four-point probe method was applied to measure the electrical resistivity. The electrical resistivity is a very important property for a core material. The higher the electrical resistivity the lower the eddy current will be leading to a decrement of core loss. The mean free path of electron transport in amorphous structure is much shorter than that of crystalline structure due to the long range disorder structure. The results show that the electrical resistivity of our ternary iron-based bulk amorphous alloys is within 200-280 micro-Ω/cm, as shown in FIG. 9. The value is 40 to 100% higher than that of amorphous ribbons of Fe—Si—B.

### EXAMPLE 3

The Casting of Fe-M-B Ternary Alloy Systems (M is One of the Sc, Sn, Zr, Hf, Nb, Ta, La, Ce, Pr, Nd, Sm, Eu, Gd, Th, Dy, Ho, Er, Yb)

In the last example, the embodiment shows that the best amorphization composition is with Fe=72 at. %, Y=6 at. % and B=22 at. %. Fe₇₂M₆B₂₂ alloys were then prepared wherein M was selected from one of the elements with radius 130% larger than Fe, such as Sc, Sn, Zr, Hf, Nb, Ta, La, Ce, Pr, Nd, Sm, Eu, Gd, Th, Dy, Ho, Er and Yb. These Fe₇₂M₆B₂₂ alloys were cast into rods of 0.5 to 2 mm in diameter, and their structure were examined by XRD.

Table 5 shows that these alloys can not be cast into a 1 mm glassy rod as M=Sn, La, Ce, Pr, Nd, Sm, Eu, Gd and Th. Amorphous state was not achievable even for those cast-rods 0.5 mm in diameter. These alloys have a common feature that these M elements do not follow our proposed rule of the necessity to form an iron-rich eutectic though they have an atomic radius larger than 130% that of Fe. On the other hand, Fe₇₂M₆B₂₂ alloys failed to form bulk amorphous rods of 0.5 mm in diameter for M being one of Zr, Hf, Nb, Ta which are with a radius less than 129% of that of Fe, even though they have Fe-rich eutectics.

TABLE 5
Casting results of Fe₇₂M₆B₂₂ alloys

| | | Glassy sample | |
|---|---|---|---|
| Element M | r_{X}/r_{Fe} ratio (%) | size | Description |
| Sn | 130 | — | No iron-rich eutectic |
| Zr | 129 | — | r_{X} < 130% r_{Fe} |
| Hf | 127 | — | r_{X} < 130% r_{Fe} |
| Nb | 115 | — | r_{X} < 130% r_{Fe} |
| Ta | 115 | — | r_{X} < 130% r_{Fe} |
| Sc | 132 | 2 mm | Good bulk GFA |
| La | 151 | — | No iron-rich eutectic |
| Ce | 147 | — | No iron-rich eutectic |
| Pr | 133 | — | No iron-rich eutectic |
| Nd | 132 | — | No iron-rich eutectic |
| Sm | 146 | — | No iron-rich eutectic |
| Eu | 160 | — | No iron-rich eutectic |
| Gd | 145 | — | No iron-rich eutectic |
| Tb | 143 | — | No iron-rich eutectic |
| Dy | 143 | ≧1 mm | Good bulk GFA |
| Ho | 142 | ≧1 mm | Good bulk GFA |
| Er | 141 | ≧1 mm | Good bulk GFA |

On the contrary, the elements such as Sc, Dy, Ho and Er have an atomic radius larger than 130% that of Fe and possess an iron-rich eutectic exhibit good glass forming ability to successfully form bulk amorphous rods with a diameter of at least 1 mm.

### EXAMPLE 4

Replacement of Fe by a Small Amount of Other Transition Metals in Fe₇₂Y₆B₂₂ Ternary Alloys

In this embodiment, we prepared multinary alloys (Fe₇₂₋ᵤXᵤ)Y₆B₂₂ in which X is one or the combination of Co, Ni, Sc, Ti, V, Cr, Mn, Cu, Zr, Nb, Mo, Hf, Ta, W, Ag, Au, Pd and Pt. These alloys were taken to cast into rods and then examined by XRD. The results are shown in Table 6.

TABLE 6
Experimental results of Example 4

| | | Glassy sample | |
|---|---|---|---|
| Replacing element | u, at. % | size | Description |
| nil | 0 | ≧2 mm | Reference |
| Co | 10 | ≧1 mm | 2 mm rod glassy |
| Co | 36 to 50 | ≧2 mm | Good GFA |
| Co | 72 | — | Crystallized |
| Ni | 10 | ≧1 mm | 2 mm rod mixture |
| Ni | 20 | — | Crystallized |
| Ni | 72 | — | Crystallized |
| Sc | 1 | ≧1 mm | 30% of 2 mm rod |
| | | | glassy |
| V or Cr | 1 | ≧1 mm | Good GFA |
| One of Mn, Cu, Ag | 0.5 | ≧1 mm | Good GFA |
| Zr | 1 | ≧2 mm | Same GFA |
| Zr | 2 | ≧1 mm | 60% of 2 mm rod |
| | | | glassy |
| Nb | 1, 2, 3 | ≧3 mm, all | Same GFA |
| Mo | 1, 2 | ≧2 mm, both | Same GFA |
| Ti | 1, 2 | ≧2 mm, both | Same GFA |
| Hf | 0.5 | ≧1 mm | Good GFA |
| Ta or W | 1, 2 | ≧2 mm, both | Same GFA |
| One of Au, Pd, Pt | 0.5 | ≧1 mm, all | Good GFA |

The results show that the alloys still keep their glass forming ability after adding a great quantity of Co up to 50 at. % or Ni up to 10 at. %. This greatly facilitates the modification of the magnetic properties. The ternary Co—Y—B and Ni—Y—B do not show bulk glassy forming ability although they are able to be amorphized by melt-spinning. On the other hand, the alloys still keep the glass forming ability after adding a small amount of additional one of Sc, Ti, V, Cr, Mn, Cu, Zr, Nb, Mo, Hf, Ta, W, Ag, Au, Pd and Pt. It shows that the small replacement amounts of transition metals do not affect the glass forming ability that is mainly dominated by Y and B contents. This, on the other hand, reveals that small amounts of impurity do not affect the glass forming ability of Fe—Y—B alloys. It is quite meaningful for industrial production.

The one who knows well of this art is able to further extend that the addition of combination of above elements do not deteriorate the glass forming ability so that the combined addition of these elements should be protected by this invention.

### EXAMPLE 5

Replacement of Fe by a Small Amount of Non-Transition Metals in Fe₇₂Y₆B₂₂ Ternary Alloys

In this example, we prepared multinary alloys (Fe₇₂₋ᵤXᵤ)Y₆B₂₂ in which Y and B were fixed at 6 and 22 respectively. We added 2-4 at. % different non-transition metals, X, such as one of Al, Ga, Sn, Bi, La, Ce and Sm to replace Fe. These alloys were cast into rods and then examined by XRD. The results are shown in Table 7.

TABLE 7
Experimental results of Example 5, (Fe₇₂₋ᵤXᵤ)Y₆B₂₂ alloys

| | | Glassy sample | |
|---|---|---|---|
| replacement | u, at. % | size | Description |
| nil | 0 | ≧2 mm | reference |
| Al | 2 | ≧2 mm | Same GFA |
| Al | 4 | ≧1 mm | 70% 2 mm glassy rod |
| Ga | 2 | ≧1 mm | Good GFA |
| Ga | 4 | ˜0.5 mm | Decreased GFA |
| Al + Ga | 2 each | ˜0.5 mm | 20% 2 mm glassy rod |
| Sn | 0.5 | ˜0.5 mm | Decreased GFA |
| Bi | 0.5 | ˜0.5 mm | Decreased GFA |
| La | 2 | ≧0.5 mm | Decreased GFA |
| Ce | 2 | ≧1 mm | Good GFA |
| Sm | 1 or 2 | ≧2 mm | Same GFA |
| Sm | 4 | ≧1 mm | Good GFA |

The results show that the modified alloys still keep their good glass forming ability to form 0.5 mm glassy rod after adding 2-4 at. % Al, Ga and small amounts of a rare earth metal. While the Sn addition decreases the glass forming ability. These results also show that it is the contents of Y and B which dominate the glass forming ability of the alloys. The small replacement amounts of non-transition metals do not affect the glass forming ability. This also reveals that small amounts of non-transition metal impurities do not affect the glass forming ability of the Fe—Y—B alloys, being quite meaningful for industrial production.

The one who knows well of this art is able to further extend that the addition of combination of the above elements do not influence the glass forming ability so that the combination of these elements should be protected by this invention.

### EXAMPLE 6

Partial Replacement of Y in Fe₇₂Y₆B₂₂ Alloy

In this example, we fixed the Fe and B content at 72 and 22 at. %, respectively, and different elements were added to partially (1-2 at %) replace Y. The elements replacing Y are one of La, Ce and Sm that are not bulk glassy forming element when singly used. The other replacements are transition metals at 2 at. %. These alloys were cast into rods and then examined by XRD. The results are shown in Table 8.

TABLE 8
Experimental results of Example 6, Fe₇₂Y₆₋ᵥB₂₂

| | | Glassy sample | |
|---|---|---|---|
| Replacement | v, at. % | size | Description |
| nil | 0 | ≧2 mm | Reference |
| La | 1 | 0.5 mm | 1 mm crystalline |
| Ce | 1 | 0.5 mm | 1 mm crystalline |
| Sm | 1˜2 | ≧1 mm | ≧1 mm crystalline |
| Nb | 2˜3 | ≧4 mm | Excellent GFA |
| Nb | 4 | ≧2 mm | Good GFA |
| Zr | 2 | ≧1 mm | |
| Sm | 4 | ≧0.5 mm | |
| Nb(3%) + Zr(2%) | 5 | ≧1 mm | |

This application reveals that the alloys exhibit excellent glass forming ability to form glassy rods of at least 4 mm in diameter as 2 to 3 at. % Y content is replaced by Nb, the best glass forming ability (GFA) in the present invention. As Nb replacement is 4 at %, the cast amorphous diameter is still 2 mm. In case of substitution by Zr or Sm, 2 at. % substitution maintains an amorphous diameter up to 1 mm. In case that 1 at. % of either La or Ce is replacing Y, the cast amorphous diameter is at least 1 mm. Y content is important for bulk amorphization. In this example, we demonstrated that by substitution with Nb and Zr, the 1 at. % Y alloy sustains a cast amorphous rods with diameter at least 1 mm.

In a further experiment, the glass forming ability of Fe₇₂Y₄Nb₂B₂₂ or Fe₇₂Y₃Nb₃B₂₂ alloy in which Fe was further replaced by either less than 50 at. % Co or less than 30 at. % Ni, the cast rods with 3 mm in diameter still showed amorphous state.

The one who knows well of this art is easy to further extend that the addition of combination of the above elements do not influence the glass forming ability so that the combination of these elements should be protected by this invention.

### EXAMPLE 7

The Modification of B in Fe—Y—B Alloys

In this example, we prepared the alloys Fe₇₂Y₆(B_{22-w}Z_{w}) in which Fe and Y contents were fixed at 72 at. % and 6 at. %, respectively and different elements were added to partly replace B. These elements include one or combination of C, N, P, Si, S and Ge. These alloys were casting into rods. Nitrogen was added by hexagonal BN compound; P was added by Fe—P and S by Fe—S. The experimental results are shown in Table 9.

The results show that the alloys still exhibit glass forming ability to form 0.5 mm glass rod after replacing B by one or combination of C, N, P, Si, S and Ge.

The one who knows well of this art is easy to further extend that the addition of combination of the above elements do not deteriorate the glass forming ability so that the combination of these elements should be protected by this invention.

TABLE 9
Experimental results of Example 7

| | | Amorphizable | |
|---|---|---|---|
| Replacement | w, at. % | diameter | Remarks |
| nil | 0 | ≧2 mm | The Reference |
| C | 2 | ≧0.5 mm | |
| C | 4 | — | |
| N | 0.3 | ≧1 mm | |
| P | 2 | ≧1 mm | |
| S | 0.2 | ≧1 mm | |
| Si | 1 | ≧1 mm | |
| Ge | 2 | ≧0.5 mm | 1 mm mixed |
| P + Si | 2P, 4Si | ≧2 mm | Good GFA |
| P + Si + C | 2P, 4Si, 2C | ≧2 mm | Good GFA |

### EXAMPLE 8

The Tolerance to Impurities of the Disclosed Embodiments

To understand the tolerance to impurities, we used industrial grade (low purity) elements as raw materials in order to confirm their industrial capability. We prepared the alloy, Fe₇₂Y₆B₂₂ with low purity elements and master alloys, Fe—P, Fe—B and Fe—S. The results show that the glass forming ability is a little bit reduced (20 to 50% less in amorphous diameters) yet not destroyed.

### EXAMPLE 9

The Existence of Nano-Crystalline Phases

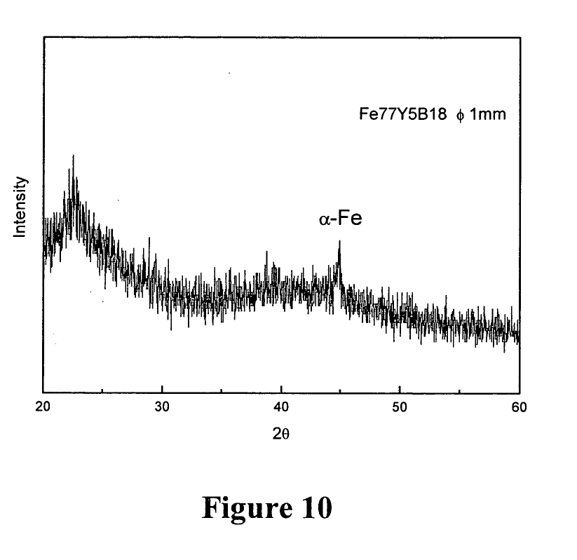

XRD was used to examine the outer regime of glass forming region in embodiment 1 and 2. The results showed that the compositions shown as the “mixed” notation in FIGS. 2 and 3 consist of mixture of amorphous and nano-crystalline phase as shown in FIG. 10. The grain size of iron nano-crystalline phase is about 20˜200 nm as calculated by the Scherrer equation. These compositions may exhibits similar or superior soft magnetic properties versus amorphous compositions.

This embodiment also shows that the mixture structure exits only in 0.5 mm and 1 mm cast rods. The 2 mm cast rods of alloys with less glass forming ability will form a cored structure which composes of an amorphous shell (the outer region) and a crystalline core (the central region). These compositions are shown in Tables 6 and 7 in embodiments 4 and 5.

There are two ternary composition regions within which 0.5 mm nano-crystalline rods in embodiments 1 to 3 can form. These regions are, for MₐX_{b}Z_{c} alloys in atomic percent, (1) 73%<a<85%, 1%<b<15%, 9%<c<15% and (2) 53%<a<62%, 2%<b<11%, 35%<c<41%. The composition regions within which 1 mm nano-crystalline rods can form are (1) 73%<a<79%, 3%<b<9%, 17%<c<19%; (2) 74%<a<78%, 2%<b<4%, 19%<c<23%; (3) 71%<a<73%, 3%<b<5%, 23%<c<25%; (4) 66%<a<70%, 4%<b<8%, 25%<c<27%, excluding b 6±0.5; and (5) 67%<a<69%, 9%<b<11%, 21%<c<23%.

Similar analyses of mixture regions in embodiments disclosed in Examples 4 to 8 were done. We also found the nano-crystalline phase as Fe is replaced by a small addition of one or combination of Sc, Ti, V, Cr, Mn, Co, Ni, Cu, Ag, Au, Pd, Pt, Zr, Nb, Mo, Hf, Ta, W, Al, Ga, Sn, Bi; and Y is replaced by a small addition of one or combination of Sc, Y, La, Ce, Sm, Dy, Ho, Er and Yb.

### EXAMPLE 10

Amorphous Fe_{100-b-c}Y_{b}B_{c} Ribbons with a Thickness at Least 0.100 mm

1) Structure Analysis

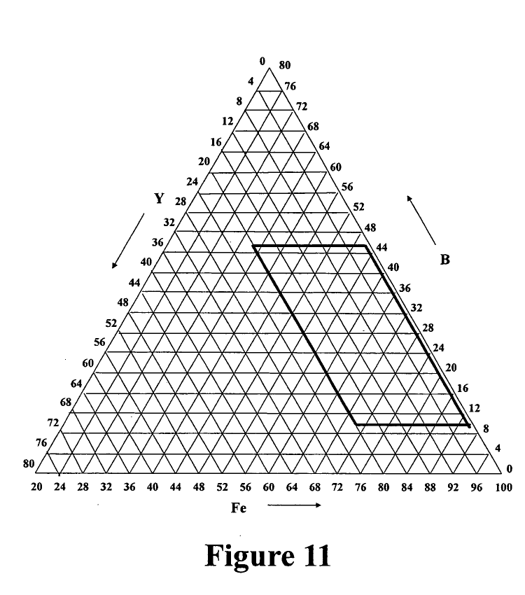

We prepared the ribbons with compositions, FeₐY_{b}B_{c}, b=1-25 at. % c=8-50 at. % a=100-b-c, with the thickness of at least 0.050˜0.150 mm and examined the structure by XRD. FIG. 11 shows the formation region of amorphous ribbons at least 0.100 mm in thickness, it is in atomic percent: 35%<a<89 at. %, 1%<b<20 at. %, and 10%<c<45 at. %. We also further examined that within the composition region 37%<a<88 at. %, 2%<b<18 at. %, 12%<c<43%, amorphous ribbons with a thickness at least 0.200 mm can be formed.

The Industrial Importance of this Invention

(1) The iron-based bulk amorphous alloys developed in this invention exhibit good soft magnetic properties such as high saturation magnetization up to 1.7 T, low coercivity force about 4˜100 A/m and high electrical resistivity about two times that of normal iron-based soft magnetic alloys. The core loss of our alloys is much lower than conventional iron silicon.
(2) The alloys exhibit good glass forming ability though they consist of only three elements. It is much better than the multi-component alloys, Fe₇₄Al₄Ga₂P₁₂B₄Si₄ (ΔTₓ=49 K) and others disclosed earlier.
(3) In the consideration of cost, the elements we used are very cheap. Comparing with the alloys Fe₇₄Al₄Ga₂P₁₂B₄Si₄ and the like developed earlier, the cost of Y is much cheaper than that of Ga. This benefits the reduction of material cost.
(4) The mechanical properties of ternary alloys consist of Fe, Y and B can be modified to be better by further additions of a small amount of other transition elements or Al and Ga to replacing Fe or Y. The glassy samples exhibit a hardness value higher than HV 650 and good corrosion resistance. The Y-containing alloys show no corrosion, stain and with unchanged magnetic properties for months under air atmosphere.
(5) This invention further reveals that there are composition regions for forming nano-crystalline phase at outer regime of amorphous forming region.

Although the invention has been explained in relation to its preferred embodiments, it is not used to limit the invention. It is to be understood that many other possible modifications and variations can be made by those skilled in the art without departing from the spirit and scope of the invention as hereinafter claimed.

1. A soft magnetic bulk amorphous alloys represented by the formula (FeₐM′_{a′})(X_{b}X′_{b′})(Z_{c}Z′_{c′}), wherein Fe is an iron, X is the other metallic element, and Z is one metalloid or non-metallic element; and M′, X′, Z′ represent the partial substitution element for Fe, X and Z, respectively; a, a′, b, b′, c, and c′ represent the atomic percentage of Fe, M′, X, X′, Z, and Z′, respectively, and a+a′+b+b′+c+c′=100%; characterized in that:
1) X is selected from one of the metallic elements with atomic radius at least 130% that of Fe; Z is selected from one of the metalloid or non-metallic elements with an atomic radius at most 86% that of Fe; and the composition range lies in 35%<a+a′<89%, 1%<b+b′<20%, and 10%<c+c′<45%;
2) Fe, and X, Z selected by the aforementioned rule should possess eutectic point with each other, wherein the Fe—X eutectic is at Fe-rich terminal of the Fe—X binary phase diagram; and
3) the substitution elements M′, X′ and Z′ are for the adjustment of properties, and their selection is not limited by the rules stated above, with their substitution amount, in atomic percent, 0.1<a′, b′, c′<40.

2. The soft magnetic bulk amorphous alloys as claimed in claim 1, wherein X is yttrium, Z is boron and no substitution elements M′, X′ and Z′ are used; and the iron-based ternary FeₐY_{b}B_{c} alloys exhibit a glass forming ability to form amorphous ribbons or sheets with a thickness at least 0.1 mm within the composition region of 35%<a<89%, 1%<b<20% and 10%<c<45%.

3. The soft magnetic bulk amorphous alloys as claimed in claim 2, wherein the iron-based ternary alloys FeₐY_{b}B_{c} exhibit a glass forming ability to form glassy rods with a diameter of at least 0.5 mm in the composition range, in atomic percentage, 54%<a<84%, 2%<b<15%, and 12%<c<39%.

4. The soft magnetic bulk amorphous alloys as claimed in claim 2, wherein the iron-based ternary alloys FeₐY_{b}B_{c} exhibit a glass forming ability to form glass rods with a diameter of at least 1 mm in the composition range, in atomic percent 66%<a<78%, 3%<b<10%, and 18%<c<27%.

5. The soft magnetic bulk amorphous alloys as claimed in claim 1, wherein X is an element selected from the group of elements Sc, Dy, Ho and Er; Z is boron and no substitution elements M′, X′ and Z′ are used (a′=b′=c′=0); and these FeₐX_{b}B_{c} alloys exhibit a glass forming ability to form glassy rods with a diameter at least 0.5 mm in the composition range, in atomic percent, 54%<a<84%, 2%<b<15%, and 12%<c<39%.

6. The soft magnetic bulk amorphous alloys as claimed in claim 1, wherein X is selected from a combination of at least two of Sc, Y, Dy, Ho and Er, Z is boron and no substitution elements M′, X′ and Z′ are used (a′=b′=c′=0); and these FeₐX_{b}B_{c} alloys exhibit a glass forming ability to form glassy rods with a diameter at least 0.5 mm in the composition range, in atomic percent, 54%<a<84%, 2%<b<15%, and 12%<c<39%.

7. The soft magnetic bulk amorphous alloys as claimed in claim 1, wherein these (FeₐM′_{a′})(X_{b}X′_{b′})(Z_{c}Z′_{c′}) alloys exhibit a glass forming ability to form glassy rods with a diameter at least 0.5 mm in the composition range, in atomic percent, 54%<a+a′<84%, 2%<b+b′<15%, and 12%<c+c′<39%; wherein M′ is selected from one or a combination of Ti, V, Cr, Mn, Co, Ni, Cu, Ag, Au, Pd, Pt, Zr, Nb, Mo, Hf, Ta, W, Al, Ga, Sn and Bi; X is Yttrium and X′ is a small amount of replacement elements selected from one or a combination of Sc, La, Ce, Sm, Zr, Ta and Nb; Z is boron and Z′ is a small amount of replacement element selected from one or combinations of C, Si, N, P, Ge and S; and the substitution amount a′, b′ c′ being 0.1% to 5%.

8. The soft magnetic bulk amorphous alloys as claimed in claim 1, wherein these (FeₐM′_{a′})(X_{b}X′_{b′})(Z_{c}Z′_{c′}) alloys exhibit a glass forming ability to form glassy rods with a diameter at least 0.5 mm in the composition range, in atomic percent, 54%<a+a′<84%, 2%<b+b′<15%, and 12%<c+c′<39%; wherein M′ is selected from one or a combination of Ti, V, Cr, Mn, Co, Ni, Cu, Ag, Au, Pd, Pt, Zr, Nb, Mo, Hf, Ta, W, Al, Ga, Sn and Bi; X is selected from one or a combination of Sc, Dy, Ho, and Er; and X′ is a small amount of replacement elements selected from one or a combination of La, Ce, Sm, Zr, Ta and Nb; Z is boron and Z′ is a small amount of replacement element selected from one or combinations of C, Si, N, P, Ge and S; and the substitution amount a′, b′, c′ is 0.1% to 5%.

9. The soft magnetic bulk amorphous alloys as claimed in claim 1, wherein these (FeₐM′_{a′})(X_{b}X′_{b′})(Z_{c}Z′_{c′}) alloys exhibit a glass forming ability to form glassy rods with a diameter at least 0.5 mm in the composition range, in atomic percent, 54%<a+a′<84%, 2%<b+b′<15%, and 12%<c+c′<39%; wherein M′ is selected from one or a combination of Ti, V, Cr, Mn, Co, Ni, Cu, Ag, Au, Pd, Pt, Zr, Nb, Mo, Hf, Ta, W, Al, Ga, Sn and Bi; X is at least two elements selected from the group Sc, Y, Dy, Ho, Er, X′ is a small amount of replacement elements selected from one or combination of La, Ce, Sm, Zr, Ta and Nb; B is boron, Z′ is a small amount of replacement element selected from one or combinations of C, Si, N, P, Ge and S; and the substitution amount a′, b′, c′ is 0.1% to 5%.

10. The soft magnetic bulk amorphous alloys as claimed in claim 1, wherein these (FeₐM′_{a′})(X_{b}X′_{b′})(Z_{c}Z′_{c′}) alloys exhibit a glass forming ability to form glassy rods with a diameter at least 3 mm in the composition range, in atomic percent, 60%<a+a′<80%, 5%<b+b′<10%, and 15%<c+c′<30%; wherein M′ is either Co or Ni, or Co and Ni, X is Y and X′ is Nb or/and Ta, Z is B, 20<a′<40, 2<b′<6, and c′=0.

11. The soft magnetic bulk amorphous alloys as claimed in claim 7, wherein Fe is not less than 50 at. %, Y is not less than 1 at. %, and boron is not less than 8 at. %.

12. The soft magnetic bulk amorphous alloys as claimed in claim 8, wherein the iron-based multinary alloys (FeₐM′_{a′})(X_{b}X′_{b′})(Z_{c}Z′_{c′}) wherein Fe is not less than 50 at. %, R is not less than 1 at. % and B is not less than 8 at. %.

13. The soft magnetic bulk amorphous alloys as claimed in claim 2, wherein the iron-based ternary alloys exhibit glass forming ability to form amorphous ribbons or sheets with a thickness at least 0.100 mm in the composition range 35%<Fe<89%, 1%<X<20% and 10%<B<45%, wherein X is Y.

14. The soft magnetic bulk amorphous alloys as claimed in claim 5, wherein the iron-based ternary and multinary alloys exhibit glass forming ability to form amorphous ribbons or sheets with a thickness at least 0.100 mm in the composition range 35%<Fe<89%, 1%<X<20% and 10%<B<45%, wherein X is an element selected from the group of elements Sc, Dy, Ho and Er.

15. The soft magnetic bulk amorphous alloys as claimed in claim 6, wherein the iron-based ternary and multinary alloys exhibit glass forming ability to form amorphous ribbons or sheets with a thickness at least 0.100 mm in the composition range 35%<Fe<89%, 1%<X<20% and 10%<B<45%, wherein X is selected from one or a combinations of Sc, Y, Dy, Ho and Er.

16. The soft magnetic bulk amorphous alloys as claimed in claim 7, wherein the iron-based multi-component (FeₐM′_{a′})(X_{b}X′_{b′})(Z_{c}Z′_{c′}) alloys exhibit glass forming ability to form amorphous ribbons or sheets with a thickness of at least 0.100 mm within the composition range 35%<a+a′<89%, 1%<b+b′<20%, 10%<c+c′<45%, a+a′+b+b′+c+c′=100; wherein M′ is selected from one or combination of Ti, V, Cr, Mn, Co, Ni, Cu, Ag, Au, Pd, Pt, Zr, Nb, Mo, Hf, Ta, W, Al, Ga, Sn and Bi. X is Yttrium, X′ is selected from one or combination of Sc, La, Ce, Sm, Zr, Ta and Nb. Z is boron, Z′ is selected from one or combination of C, Si, N, P, Ge and S.

17. The soft magnetic bulk amorphous alloys as claimed in claim 8, wherein the iron-based multi-component (FeₐM′_{a′})(X_{b}X′_{b′})(Z_{c}Z′_{c′}) alloys exhibit glass forming ability to form amorphous ribbons or sheets with a thickness of at least 100 micrometers within the composition range 35%<a<89%, 1%<b<20%, 10%<c<45%, a+b+c=100; wherein M′ is selected from one or a combination of Ti, V, Cr, Mn, Co, Ni, Cu, Ag, Au, Pd, Pt, Zr, Nb, Mo, Hf, Ta, W, Al, Ga, Sn and Bi; X is selected from one or a combination of Sc, Dy, Ho, and Er; X′ is selected from one or a combination of La, Ce, Sm, Zr, Ta and Nb, B is boron, Z′ is selected from one or a combination of C, Si, N, P, Ge and S; and the substitution amount a′, b′, c′ is 0.1% to 5%.

18. The soft magnetic bulk amorphous alloys as claimed in claim 9, wherein the iron-based multi-component (FeₐM′_{a′})(X_{b}X′_{b′})(Z_{c}Z′_{c′}) alloys exhibit glass forming ability to form amorphous ribbons or sheets with a thickness of at least 100 micrometers within the composition range 35%<a<89%, 1%<b<20%, 10%<c<45%, a+b+c=100; wherein M′ is selected from one or a combination of Ti, V, Cr, Mn, Co, Ni, Cu, Ag, Au, Pd, Pt, Zr, Nb, Mo, Hf, Ta, W, Al, Ga, Sn and Bi; X is selected from one or a combination of Sc, Y, Dy, Ho, and Er; X′ is selected from one or a combination of La, Ce, Sm, Zr, Ta and Nb, B is boron, Z′ is selected from one or a combination of C, Si, N, P, Ge and S; and the substitution amount a′, b′, c′ is 0.1% to 5%.

19. A ternary and multinary iron-based nanocrystalline alloys represented by formula MₐX_{b}Z_{c}, characterized in that:
M mainly contains iron and may contain a small amount of other ferromagnetic or non-ferromagnetic elements; X is an element or the mixture of the elements with atomic radius at least 130% that of iron and a small amount of other additive elements; Z is an element or the mixture of elements with radius at most 86% that of Fe; a, b and c being the atomic percentage of M, X and Z respectively, and a+b+c=100;
the composition range to form nanocrystalline rods with a diameter of at least 0.5 mm lie in two composition regions: (1) 73%<a<85%, 1%<b<15%, 9%<c<15%, and (2) 53%<a<62%, 2%<b<11%, 35%<c<41%; and
the composition range to form nanocrystalline rods with a diameter of at least 1 mm lie in five composition regions: (1) 73%<a<79%, 2%<b<9%, 17%<c<19%; (2) 74%<a<78%, 2%<b<4%, 19%<c<23%; (3) 71%<a<73%, 3%<b<5%, 23%<c<25%; (4) 65%<a<70%, 4%<b<9%, 25%<c<27%, excluding b=6±0.5; and (5) 67%<a<69%, 9%<b<11%, 21%<c<23%.

20. The ternary and multinary iron-based nanocrystalline alloys as claimed in claim 19, wherein M further contains one or a combination of Co, Ni, Ti, V, Cr, Mn, Cu, Ag, Au, Pd, Pt, Zr, Nb, Mo, Hf, Ta, W, Al, Ga, Sn and Bi; X is selected from one or a combination of Sc, Y, Dy, Ho, Er and can be replaced in part by La, Ce, Sm, Zr, Ta, Nb; Z is selected from one or a combination of B, C, Si, N, P, Ge and S.
